(19) United States
(12) Patent Application Publication
(10) Pub. No.: US 2014/0265687 A1
(43) Pub. Date: Sep. 18, 2014

(54) SPINDLE MOTOR

(71) Applicant: SAMSUNG ELECTRO-MECHANICS CO., LTD., Suwon (KR)

(72) Inventors: Shin Young CHEONG, Suwon (KR); Hoon Hee Han, Suwon (KR)

(73) Assignee: SAMSUNG ELECTRO-MECHANICS CO., LTD., Suwon (KR)

(21) Appl. No.: 13/955,649

(22) Filed: Jul. 31, 2013

(30) Foreign Application Priority Data
Mar. 13, 2013 (KR) 10-2013-0026635

(51) Int. Cl. F16C 33/04; H02K 7/08

(52) U.S. Cl. CPC F16C 33/04; H02K 7/086
USPC 310/90

(57) ABSTRACT

There is provided a spindle motor including: a rotating body including a sleeve part disposed between a thrust member and a flange part of a shaft, a connection part extended from the sleeve part, and a rotor hub part extended from the connection part, 0.5 mm<min{L1, L2}<{(H−0.3)−(h1+h2+h3)}/cos θ is satisfied.

### CROSS-REFERENCE TO RELATED APPLICATIONS

This application claims the priority of Korean Patent Application No. 10-2013-0026635 filed on Mar. 13, 2013, in the Korean Intellectual Property Office, the disclosure of which is incorporated herein by reference.

### BACKGROUND OF THE INVENTION

1. Field of the Invention

The present invention relates to a spindle motor.

2. Description of the Related Art

An information recording and reproducing device such as a hard disk drive, or the like, includes a spindle motor installed therein in order to rotate a disk. Further, in the hard disk drive, a fixed shaft-type spindle motor in which a shaft having strong impact resistance is fixed to a housing of the hard disk drive may be used.

That is, the spindle motor may be provided with a fixed shaft in order to prevent information stored on the disk from being unreadable or preventing information from being written thereto due to external impacts.

Meanwhile, in a structure in which the shaft is fixedly installed, a sleeve serves as a rotating member rotated around the shaft, and a rotor hub is coupled to the sleeve to configure a rotation body.

In addition, the rotor hub may be installed while press-fitting the sleeve so that it may be rotated together with the sleeve. That is, the sleeve and the rotor hub may be attached to each other in a press-fitting scheme.

However, in the case in which the sleeve and the rotor hub are attached to each other in the press-fitting scheme, the sleeve may be deformed due to press-fitting force. In order to prevent this problem, a structure in which the sleeve and the rotor hub are formed integrally with each other has been developed.

However, in accordance with the trend toward thickness of the spindle motor, a connection part between the sleeve and the rotor hub may be permanently deformed due to external force or external impacts.

Further, in the case in which the shaft is fixedly installed as a fixed member, a contact area between the shaft and a bonding surface to which the shaft is bonded may not be sufficiently provided, such that coupling force between the shaft and the fixed member may be low.

That is, the shaft and the fixed member may be easily separated from each other at the time of external impacts.

### RELATED ART DOCUMENT

### (Patent Document 1) Korean Patent Laid-Open Publication No. 2010-0064349

### SUMMARY OF THE INVENTION

An aspect of the present invention provides a spindle motor capable of decreasing inclination of a disk at the time of clamping the disk.

An aspect of the present invention also provides a spindle motor capable of decreasing a phenomenon in which a shaft is separated from a stator due to external impacts.

According to an aspect of the present invention, there is provided a spindle motor including: a base member provided with an installation part on which a stator core is fixedly installed; a shaft including a body part having a cylindrical shape, a flange part extended from a lower end portion of the body part, and a bonding part extended from the flange part in an axial direction and bonded to an inner peripheral surface of the installation part; a thrust member fixedly installed on an upper end portion of the shaft; and a rotating body including a sleeve part disposed between the thrust member and the flange part of the shaft, a connection part extended from the sleeve part, and a rotor hub part extended from the connection part, wherein when the shortest distance between the thrust member and the bonding part is L1, the shortest distance between the thrust member and the installation part is L2, a thickness of a hard disk drive is H, a vertical distance from the uppermost surface of the thrust member to the lowermost surface thereof is h1, a thickness of the flange part is h2, a vertical distance of the bonding part from an upper surface of the flange part is h3, and an angle between a line extended from an outer peripheral surface of the thrust member and a connection line having a smaller value between L1 and L2 is θ, and when a thickness of the connection part has the same value as a smaller value between L1 and L2, 0.5 mm<min{L1, L2}<{(H−0.3)−(h1+h2+h3)}/cos θ is satisfied.

The spindle motor may further include a cover member fixedly installed on the rotating body or the thrust member so as to prevent a lubricating fluid from being leaked from a clearance formed by the rotating body and the thrust member.

The shaft may include an outer diameter reduction part to which the thrust member is bonded.

The shaft may have a greater degree of roughness in a portion to which the thrust member is bonded than in other portions.

The thrust member may include an insertion protrusion part inserted into an insertion groove formed in the sleeve part.

The outer peripheral surface of the thrust member may be provided with an inclined surface so as to form, together with a facing surface of the rotating body disposed to face the outer peripheral surface of the thrust member, an interface between a lubricating fluid and air.

A lower end portion of an outer peripheral surface of the sleeve part may be provided with an inclined part so as to form, together with an inner peripheral surface of the bonding part, an interface between a lubricating fluid and air.

The sleeve part may be provided with a circulation hole formed in the axial direction.

Upper and lower radial dynamic grooves may be formed in at least one of an inner peripheral surface of the sleeve part and an outer peripheral surface of the body part.

An upper thrust dynamic groove may be formed in at least one of a lower surface of the thrust member and an upper surface of the sleeve part.

A lower thrust dynamic groove may be formed in at least one of an upper surface of the flange part and a lower surface of the sleeve part.

The rotor hub part may be installed with a driving magnet disposed to face a front edge of the stator core, and the magnetic center of the driving magnet in the axial direction may be disposed in a position higher than that of the magnetic center of the stator core in the axial direction.

The sleeve part, the connection part, and the rotor hub part may be formed integrally with each other.

According to another aspect of the present invention, there is provided a spindle motor including: a base member provided with an installation part on which a stator core is fixedly installed; a lower thrust member inserted into the installation part to thereby be fixedly installed in the installation part and including a disk part having a disk shape and a bonding part extended from an edge of the disk part; a shaft having a lower end portion fixedly installed on the lower thrust member and an upper end portion provided with an upper thrust part; and a rotating body including a sleeve part disposed between the upper thrust part and the lower thrust member, a connection part extended from the sleeve part, and a rotor hub part extended from the connection part, wherein when the shortest distance between the upper thrust part and the bonding part is L1, the shortest distance between the upper thrust part and the installation part is L2, a thickness of a hard disk drive is H, a vertical distance from the uppermost surface of the upper thrust part to the lowermost surface thereof is h1, a thickness of the disk part is h2, a vertical distance of the bonding part from the disk part is h3, and an angle between a line extended from an outer peripheral surface of the upper thrust part and a connection line having a smaller value between L1 and L2 is θ, and when a thickness of the connection part has the same value as a smaller value between L1 and L2, 0.5 mm<min{L1, L2}<{(H−0.3)−(h1+h2+h3)}/cos θ is satisfied.

The spindle motor may further include a cover member fixedly installed on the rotating body or the upper thrust part so as to prevent a lubricating fluid from being leaked from a clearance formed by the rotating body and the upper thrust part.

The shaft may have a greater degree of roughness in a portion to which the lower thrust member is bonded than in other portions.

The shaft may include an outer diameter reduction part disposed at a lower end portion thereof, wherein the outer diameter reduction part has the lower thrust member bonded thereto.

The upper thrust part may include a flange extended from the upper end portion of the shaft in a radial direction and a protrusion jaw extended from an edge of the flange in a downward axial direction.

The protrusion jaw may be inserted into an insertion groove formed in the sleeve part.

An upper thrust dynamic groove may be formed in at least one of a lower surface of the flange and an upper surface of the sleeve part.

The sleeve part may be provided with a circulation hole formed in the axial direction.

The sleeve part, the connection part, and the rotor hub part may be formed integrally with each other.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating a spindle motor according to an embodiment of the present invention;

FIG. 2 is an enlarged view of part A of FIG. 1;

FIG. 3 is a graph for describing an effect of the spindle motor according to the embodiment of the present invention;

FIG. 4 is a schematic cross-sectional view illustrating a spindle motor according to another embodiment of the present invention;

FIG. 5 is an enlarged view illustrating part B of FIG. 4;

FIG. 6 is a schematic cross-sectional view illustrating a spindle motor according to another embodiment of the present invention; and

FIG. 7 is a schematic cross-sectional view illustrating a spindle motor according to another embodiment of the present invention.

### DETAILED DESCRIPTION OF THE EMBODIMENTS

Embodiments of the present invention will now be described in detail with reference to the accompanying drawings. The embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the accompanying drawings of the present invention, shapes and dimensions of components may be exaggerated for clarity.

FIG. 1 is a schematic cross-sectional view illustrating a spindle motor according to an embodiment of the present invention; FIG. 2 is an enlarged view of part A of FIG. 1; and

FIG. 3 is a graph for describing an effect of the spindle motor according to the embodiment of the present invention.

Referring to FIGS. 1 through 3, the spindle motor 100 according to the embodiment of the present invention may include a base member 110, a shaft 120, a thrust member 130, a rotating body 140, and a cover member 180 by way of example.

Meanwhile, the spindle motor 100 according to the embodiment of the present invention may be, for example, a motor used in an information recording and reproducing device such as a hard disk drive, or the like.

Here, terms with respect to directions will first be defined. As viewed in FIG. 1, an axial direction refers to a vertical direction, that is, a direction from a lower end portion of the shaft 120 toward an upper end portion thereof or a direction from the upper end portion of the shaft 120 toward the lower end portion thereof, and a radial direction refers to a horizontal direction, that is, a direction from the shaft 120 toward an outer peripheral surface of the rotating body 140 or from the outer peripheral surface of the rotating body 140 toward the shaft 120.

In addition, a circumferential direction refers to a rotation direction along the outer peripheral surface of the shaft 120 or the rotating body 140.

The base member 110 may be provided with an installation part 112 on which a stator core 102 is installed. The installation part 112 may form an installation hole 112a into which the above-mentioned shaft 120 is inserted and from which the shaft 120 is extended in an upward axial direction.

Meanwhile, the installation part 112 may include a support surface 112b formed on an outer peripheral surface thereof, wherein the support surface 112b supports the stator core 102. As an example, the stator core 102 may be fixedly installed on the installation part 112 in a state in which it is seated on the support surface 112b of the installation part 112.

Although the case in which an inner diameter part of the stator core 102 is seated on the installation part 112 of the base member 110 has been described byway of example in the present embodiment, the present invention is not limited thereto. That is, the stator core 102 may also be installed on a separate installation member or the shaft of which a shape is changed in order to install the stator core 102. In this case, the base member 110 may not be provided with the installation part 112.

The shaft 120 may include a body part 122 having a cylindrical shape, a flange part 124 extended from a lower end portion of the body part 122, and a bonding part 126 extended from the flange part 124 in the axial direction and bonded to an inner peripheral surface of the installation part 112.

In other words, the shaft 120 may be fixedly installed on the installation part 112 of the base member 110.

In addition, the flange part 124 may have a disk shape, and the bonding part 126 may have a cylindrical shape in which it is extended from an edge of the flange part 124. An inner space of which an upper portion is opened may be formed by the body part 122, the flange part 124, and the bonding part 126.

In addition, the shaft 120 may include an outer diameter reduction part 122a disposed at an upper end portion thereof, wherein the outer diameter reduction part 122a has the thrust member 130 bonded thereto. That is, an upper end portion of the body part 122 may be provided with the outer diameter reduction part 122a to which the thrust member 130 is bonded.

In addition, the shaft 120 may have a roughness greater in a portion to which the thrust member 130 is bonded than in other portions. In other words, the outer diameter reduction part 122a may have a surface rougher than other portions of the body part 122.

Therefore, coupling force between the thrust member 130 and the shaft 120 at the time of installing the thrust member 130 may be increased.

Meanwhile, the shaft 120 may have a screw hole 122b recessed from an upper surface thereof and formed so as to be coupled to an upper case (not shown) of a hard disk drive.

In addition, the outer diameter reduction part 122a may have an adhesive groove 122c formed at a lower end portion thereof, wherein the adhesive groove 122c is filled with an adhesive applied in order to bond the shaft 120 and the thrust member 130 to each other. Further, the adhesive groove 122c may be filled with the adhesive to increase coupling force between the shaft 120 and the thrust member 130.

Meanwhile, an upper edge of the body part 122 may be rounded so that the thrust member 130 may be easily attached thereto. Alternatively, the upper edge of the body part 122 may be provided with a chamfer.

The thrust member 130 may be fixedly installed on the upper end portion of the shaft 120. To this end, the thrust member 130 may have a through-hole 132 formed therein, and a lower end portion of an inner peripheral surface of the thrust member 130 may be provided with a chamfer or may be rounded so the thrust member 130 is easily attached to the shaft 120.

Meanwhile, the thrust member 130 may include an insertion protrusion part 134 inserted into an insertion groove 152 formed in a sleeve part 150 of the rotation body 140 to be described below. As described above, since the insertion protrusion part 134 is formed on the thrust member 130, an amount of filled lubricating fluid may be increased.

In addition, the outer peripheral surface of the thrust member 130 may be provided with an inclined surface 136 so as to form, together with a facing surface 142 of the rotating body 140 disposed to face the outer peripheral surface of the thrust member 130, an interface between the lubricating fluid and air (that is, a liquid-vapor interface). More specifically, an upper end portion of the outer peripheral surface of the thrust member 130 may be provided with the inclined surface 136 so that an outer diameter of the thrust member 130 is decreased, and the liquid-vapor interface may be formed in a clearance formed by the inclined surface 136 and the facing surface 142 of the rotating body 140 by a capillary phenomenon.

In addition, the thrust member 130 may have a step part 138 formed at an upper surface thereof.

The rotating body 140 may include the sleeve part 150 disposed between the thrust member 130 and the flange part 124 of the shaft 120, a connection part 160 extended from the sleeve part 150, and a rotor hub part 170 extended from the connection part 160.

Meanwhile, the sleeve part 150, the connection part 160, and the rotor hub part 170 may be formed integrally with each other.

The sleeve part 150 may form, together with the shaft 120 and the thrust member 130, a bearing clearance in which the lubricating fluid is provided. In addition, the sleeve part 150 may be provided with a shaft hole 151 through which body part 122 of the shaft 120 penetrates.

Meanwhile, a lower end portion of an outer peripheral surface of the sleeve part 150 may be provided with an inclined part 153 so as to form, together with an inner peripheral surface of the bonding part 126, an interface between the lubricating fluid and air.

In addition, the spindle motor 100 according to the embodiment of the present invention may be provided with two liquid-vapor interfaces and have a full-fill structure in which the lubricating fluid is provided in all of the bearing clearances.

In addition, the sleeve part 150 may be provided with a circulation hole 154 formed in the axial direction. The circulation hole 154 may have one end opened to the above-mentioned insertion groove 152 and the other end opened to a lower surface of the sleeve part 150.

Meanwhile, the sleeve part 150 may include upper and lower radial dynamic grooves 155 and 156 formed in an inner peripheral surface thereof, wherein the upper and lower radial dynamic grooves 155 and 156 are disposed to be spaced apart from each other. At the time of rotation of the rotating body 140, fluid dynamic pressure is generated by the upper and lower radial dynamic grooves 155 and 156, such that the rotating body 140 may be more stably rotated.

However, although the case in which the upper and lower radial dynamic grooves 155 and 156 are formed in the inner peripheral surface of the sleeve part 150 has been described by way of example in the present embodiment; the present invention is not limited thereto. That is, the upper and lower radial dynamic grooves 155 and 156 may also be formed in an outer peripheral surface of the body part 122 of the shaft 120.

In addition, the upper and lower radial dynamic grooves 155 and 156 may have a herringbone or spiral pattern.

Further, the sleeve part 150 may have an upper thrust dynamic groove 157 formed in an upper surface thereof. The upper thrust dynamic groove 157 may be disposed inwardly of the insertion groove 152 in the radial direction.

Meanwhile, although the case in which the upper thrust dynamic groove 157 is formed in the upper surface of the sleeve part 150 has been described by way of example in the present embodiment, the present invention is not limited thereto. That is, the upper thrust dynamic groove 157 may also be formed in a lower surface of the thrust member 130.

In addition, the sleeve part 150 may have a lower thrust dynamic groove 158 formed in a lower surface thereof. Further, the lower thrust dynamic groove 158 may be disposed inwardly of a region in which the circulation hole 154 is formed so as not to interfere with the circulation hole 154.

Meanwhile, although the case in which the lower thrust dynamic groove 158 is formed in the lower surface of the sleeve part 150 has been described by way of example in the present embodiment, the present invention is not limited thereto. That is, the lower thrust dynamic groove 158 may also be formed in an upper surface of the flange part 124.

The connection part 160 may be extended from the sleeve part 150 and may serve to connect the sleeve part 150 and the rotor hub part 170 to each other. Meanwhile, the connection part 160 may have a predetermined thickness, which will be described in detail below.

The rotor hub part 170 may be extended from the connection part 160. Meanwhile, the rotor hub part 170 may include a body 172 having a disk shape, a cylindrical wall body 174 extended from an edge of the body 172 in a downward axial direction and having a driving magnet 174a installed thereon, and a disk supporting jaw 176 extended from a distal end portion of the cylindrical wall body 174 in the radial direction.

Meanwhile, an inner surface of the driving magnet 174a may be disposed to face a front edge of the stator core 102.

Meanwhile, the driving magnet 174a may be a permanent magnet generating magnetic force having a predetermined strength by alternately magnetizing an N pole and an S pole thereof in the circumferential direction.

Here, a rotational driving scheme of the rotating body 140 will be schematically described. When power is supplied to a coil 101 wound around the stator core 102, driving force capable of rotating the rotating body 140 may be generated by an electromagnetic interaction between the stator core 102 having the coil 101 wound therearound and the driving magnet 174a to rotate the rotating body 140.

That is, the driving magnet 174a and the stator core 102 disposed to face the driving magnet 174a and having the coil 101 wound therearound may electromagnetically interact with each other to rotate the rotating body 140.

Meanwhile, the magnetic center of the driving magnet 174a in the axial direction may be disposed in a position higher than that of the magnetic center of the stator core 102 in the axial direction. Therefore, force directed toward the downward axial direction may be generated in the rotating body 140 by the interaction between the driving magnet 174a and the stator core 102.

Next, a more detailed description for the thickness of the connection part 160 will be provided below.

First, the shortest distance between the thrust member 130 and the bonding part 126 is defined as L1, the shortest distance between the thrust member 130 and the installation part 112 is defined as L2, a thickness of the hard disk drive is defined as H, a vertical distance from the uppermost surface of the thrust member 130 to the lowermost surface thereof is defined as h1, a thickness of the flange part 124 is defined as h2, a vertical distance of the bonding part 126 from the upper surface of the flange part 124 is defined as h3, and an angle between a line extended from the outer peripheral surface of the thrust member 130 and a connection line having a smaller value between L1 and L2 is defined as θ.

Meanwhile, the thickness of the connection part 160 may be determined by the smaller value between L1 and L2.

In addition, the smaller value between L1 and L2 may satisfy 0.5 mm<min{L1, L2}<{(H−0.3)−(h1+h2+h3)}/cos θ.

That is, when the thickness of the connection part 160 has the same value as the smaller value between L1 and L2, it may have a value greater than 0.5 mm and smaller than a value of {(H−0.3)−(h1+h2+h3)}/cos θ.

In addition, it could be appreciated that in the case in which the thickness of the connection part 160 is smaller than 0.5 mm as in the graph shown in FIG. 3, a displacement of the disk supporting jaw 176 of the rotor hub part 170 in the axial direction is rapidly increased.

Therefore, the thickness of the connection part 160 needs to be greater than 0.5 mm.

In addition, the thickness of the connection part 160 needs to have the value smaller than the value of {(H−0.3)−(h1+h2+h3)}/cos θ.

As described above, since the thickness of the connection part 160 is in the above-mentioned range, inclination of a disk due to external force applied at the time of installing a clamp may be decreased.

That is, a phenomenon in which an edge of the rotor hub part 170 sags in the downward axial direction due to the external force applied at the time of installing the clamp may be decreased. In other words, the edge of the rotor hub part 170 may sag in the downward axial direction by an allowable deformation amount at the time of clamping the disk.

The cover member 180 may be fixedly installed on the rotating body 140 so as to prevent the lubricating fluid from being leaked from a clearance formed by the rotating body 140 and the thrust member 130.

Meanwhile, the cover member 180 may have a bent part 182 bonded to the rotating body 140 and a sealing part 184 bent from the bent part 182 in an inner diameter direction. An inner diameter portion of the sealing part 184 may be disposed over the step part 138 of the thrust member 130 described above.

Therefore, a phenomenon in which the lubricating is scattered from the liquid-vapor interface disposed between the outer peripheral surface of the thrust member 130 and the facing surface 142 of the rotating body 140 to the outside may be prevented.

As described above, since the thickness of the connection part 160 has a value greater than 0.5 mm and smaller than the value of {(H−0.3)−(h1+h2+h3)}/cos θ, the inclination of the disk due to the external force applied at the time of installing the clamp may be decreased.

That is, a phenomenon in which an edge of the rotor hub part 170 sags in the downward axial direction due to the external force applied at the time of installing the clamp may be decreased. In other words, the edge of the rotor hub part 170 may sag in the downward axial direction by an allowable deformation amount at the time of clamping the disk.

The shaft 120 includes the flange part 124 and the bonding part 126, such that separation of the shaft 120 due to external impacts may be decreased.

Further, a surface roughness of the upper end portion of the shaft 120 to which the thrust member 130 is bonded is changed, such that separation between the shaft 120 and the thrust member 130 due to the external impacts may be decreased.

Hereinafter, a spindle motor according to another embodiment of the present invention will be described with reference to the accompanying drawings.

FIG. 4 is a schematic cross-sectional view illustrating a spindle motor according to another embodiment of the present invention; and FIG. 5 is an enlarged view illustrating part B of FIG. 4.

Referring to FIGS. 4 and 5, the spindle motor 200 according to another embodiment of the present invention may include a base member 210, a lower thrust member 220, a shaft 230, a rotating body 240, and a cover member 260 by way of example.

The base member 210 may include an installation part 212 on which a stator core 202 is installed. The installation part 212 may form an installation hole 212a into which the above-mentioned shaft 220 is inserted and be extended in an upward axial direction.

Meanwhile, the installation part 212 may include a support surface 212b formed on an outer peripheral surface thereof, wherein the support surface 212b supports the stator core 202. As an example, the stator core 202 may be fixedly installed on the installation part 212 in a state in which it is seated on the support surface 212b of the installation part 212.

The lower thrust member 220 may be inserted into the installation part 212 to thereby be fixedly installed in the installation part 212. Meanwhile, the lower thrust member 220 may include a disk part 222 having a disk shape and a bonding part 224 extended from an edge of the disk part 222.

In addition, the disk part 222 may have a mounting hole 222a formed at a central portion thereof, wherein the mounting hole 222a has the shaft 230 inserted thereinto.

Further, the bonding part 224 may be bonded to the installation part 212 of the base member 210 described above in at least one of an adhesion scheme, a press-fitting scheme, and a welding scheme.

The shaft 230 may have a lower end portion fixedly installed on the lower thrust member 220. Meanwhile, the shaft 230 may have an upper end portion provided with an upper thrust part 232.

In addition, the upper thrust part 232 may include a flange 232a extended from the upper end portion of the shaft 230 in the radial direction and a protrusion jaw 232b extended from an edge of the flange 232a in the downward axial direction.

The protrusion jaw 232b may be inserted into an insertion groove 252 of a sleeve part 250 to be described below. As described above, since the protrusion jaw 232b has an axial length sufficient to be inserted into the insertion groove 252 of the sleeve part 250, an amount of provided lubricating fluid may be increased.

Meanwhile, an outer peripheral surface of the upper thrust part 232 may be provided with an inclined surface 232c so as to form, together with a facing surface 242 of the rotating body 240 disposed to face the outer peripheral surface of the upper thrust part 232, an interface between the lubricating fluid and air (that is, a liquid-vapor interface).

More specifically, an upper end portion of the outer peripheral surface of the upper thrust part 232 may be provided with the inclined surface 232c so that an outer diameter of the upper thrust part 232 is decreased, and the liquid-vapor interface may be formed in a clearance formed by the inclined surface 232d and the facing surface 242 of the rotating body 240 by a capillary phenomenon.

In addition, the upper thrust part 232 may have a step part 232d formed at an upper surface thereof.

Meanwhile, the shaft 230 may have a roughness greater in a portion to which the lower thrust member 220 is bonded than in other portions. In other words, the lower end portion of the shaft 230 may have a surface rougher than other portions.

Therefore, coupling force between the lower thrust member 220 and the shaft 230 may be increased.

However, although the case in which the shaft 230 and the lower thrust member 220 are bonded to each other by an adhesive has been described by way of example in the present embodiment, the present invention is not limited thereto. That is, the shaft 230 and the lower thrust member 220 may also be bonded to each other by welding.

In addition, the shaft 230 may have a screw hole 236 recessed from an upper surface thereof and formed so as to be coupled to an upper case (not shown) of a hard disk drive.

Meanwhile, an edge of the lower end portion of the shaft 230 and/or a lower end portion of an inner surface of the lower thrust member 220 may be provided with a rounded part and a chamfer in order to facilitate attachment of the shaft 230 to the lower thrust member 220.

The rotating body 240 may include the sleeve part 250 disposed between the upper thrust part 232 and the lower thrust member 220, a connection part 260 extended from the sleeve part 250, and a rotor hub part 270 extended from the connection part 260.

Meanwhile, the sleeve part 250, the connection part 260, and the rotor hub part 270 may be formed integrally with each other.

The sleeve part 250 may form, together with the lower thrust member 220 and the shaft 230, a bearing clearance in which the lubricating fluid is provided. In addition, the sleeve part 250 may be provided with a shaft hole 251 through which the shaft 230 penetrates.

Meanwhile, a lower end portion of an outer peripheral surface of the sleeve part 250 may be provided with an inclined part 253 so as to form, together with an inner peripheral surface of the bonding part 224 of the lower thrust member 220, an interface between the lubricating fluid and air.

In addition, the spindle motor 200 according to another embodiment of the present invention may be provided with two liquid-vapor interfaces and have a full-fill structure in which the lubricating fluid is provided in all of the bearing clearances.

In addition, the sleeve part 250 may be provided with a circulation hole 254 formed in the axial direction. The circulation hole 254 may have one end opened to the above-mentioned insertion groove 252 and the other end opened to a lower surface of the sleeve part 250.

Meanwhile, the sleeve part 250 may include upper and lower radial dynamic grooves 255 and 256 formed in an inner peripheral surface thereof, wherein the upper and lower radial dynamic grooves 255 and 256 are disposed to be spaced apart from each other. At the time of rotation of the rotating body 240, fluid dynamic pressure is generated by the upper and lower radial dynamic grooves 255 and 256, such that the rotating body 240 may be more stably rotated.

However, although the case in which the upper and lower radial dynamic grooves 255 and 256 are formed in the inner peripheral surface of the sleeve part 250 has been described by way of example in the present embodiment; the present invention is not limited thereto. That is, the upper and lower radial dynamic grooves 255 and 256 may also be formed in an outer peripheral surface of the shaft 230.

In addition, the upper and lower radial dynamic grooves 255 and 256 may have a herringbone or spiral pattern.

Further, the sleeve part 250 may have an upper thrust dynamic groove 257 formed in an upper surface thereof. The upper thrust dynamic groove 257 may be disposed inwardly of the insertion groove 252 in the radial direction.

Meanwhile, although the case in which the upper thrust dynamic groove 257 is formed in the upper surface of the sleeve part 250 has been described by way of example in the present embodiment, the present invention is not limited thereto. That is, the upper thrust dynamic groove 257 may also be formed in a lower surface of the upper thrust part 232 of the shaft 230.

In addition, the sleeve part 250 may have a lower thrust dynamic groove 258 formed in a lower surface thereof. Further, the lower thrust dynamic groove 258 may be disposed inwardly of a region at which the circulation hole 254 is formed so as not to interfere with the circulation hole 254.

Meanwhile, although the case in which the lower thrust dynamic groove 258 is formed in the lower surface of the sleeve part 250 has been described by way of example in the present embodiment, the present invention is not limited thereto. That is, the lower thrust dynamic groove 258 may also be formed in an upper surface of the disk part 222 of the lower thrust member 220.

The connection part 260 may be extended from the sleeve part 250 and serve to connect the sleeve part 250 and the rotor hub part 270 to each other. Meanwhile, the connection part 260 may have a predetermined thickness, which will be described below in detail.

The rotor hub part 270 may be extended from the connection part 260. Meanwhile, the rotor hub part 270 may include a body 272 having a disk shape, a cylindrical wall body 274 extended from an edge of the body 272 in the downward axial direction and having a driving magnet 274a installed thereon, and a disk supporting jaw 276 extended from a distal end portion of the cylindrical wall body 274 in the radial direction.

Meanwhile, an inner surface of the driving magnet 274a may be disposed to face a front edge of the stator core 202.

In addition, the magnetic center of the driving magnet 274a in the axial direction may be disposed in a position higher than that of the magnetic center of the stator core 102 in the axial direction. Therefore, force directed toward the downward axial direction may be generated in the rotating body 140 by the interaction between the driving magnet 174a and the stator core 102.

Next, a more detailed description for the thickness of the connection part 260 will be provided below.

First, the shortest distance between the upper thrust part 232 and the bonding part 224 is defined as L1, the shortest distance between the upper thrust part 232 and the installation part 212 is defined as L2, a thickness of the hard disk drive is defined as H, a vertical distance from the uppermost surface of the upper thrust part 232 to the lowermost surface thereof is defined as h1, a thickness of the disk part 222 is defined as h2, a vertical distance of the bonding part 224 from the disk part 222 is defined as h3, and an angle between a line extended from the outer peripheral surface of the upper thrust part 232 and a connection line having a smaller value between L1 and L2 is defined as θ.

Meanwhile, the thickness of the connection part 260 may have the same value as the smaller value between L1 and L2.

In addition, the smaller value between L1 and L2 may satisfy 0.5 mm<min{L1, L2}<{(H−0.3)−(h1+h2+h3)}/cos θ.

That is, when the thickness of the connection part 260 has the same value as the smaller value between L1 and L2, it may have a value greater than 0.5 mm and smaller than a value of {(H−0.3)−(h1+h2+h3)}/cos θ.

As described above, since the thickness of the connection part 260 is in the above-mentioned range, inclination of a disk due to external force applied at the time of installing a clamp may be decreased.

That is, a phenomenon in which an edge of the rotor hub part 270 sags in the downward axial direction due to the external force applied at the time of installing the clamp may be decreased. In other words, the edge of the rotor hub part 270 may sag in the downward axial direction in an allowable deformation amount at the time of clamping the disk.

The cover member 280 may be fixedly installed on the rotating body 240 so as to prevent the lubricating fluid from being leaked from a clearance formed by the rotating body 240 and the upper thrust part 232.

Meanwhile, the cover member 280 may have a bent part 282 bonded to the rotating body 240 and a sealing part 284 bent from the bent part 282 in the inner diameter direction. An inner diameter portion of the sealing part 284 may be disposed over the step part 232 of the upper thrust part 232 described above.

Therefore, a phenomenon in which the lubricating is scattered from the liquid-vapor interface disposed between the outer peripheral surface of the upper thrust part 232 and the facing surface 242 of the rotating body 240 to the outside may be prevented.

Hereinafter, a spindle motor according to another embodiment of the present invention will be described with reference to the accompanying drawings. However, the same components as the components of the spindle motor according to another embodiment of the present invention described above will be denoted by the same reference numerals, and a detailed description thereof will be omitted.

FIG. 6 is a schematic cross-sectional view illustrating a spindle motor according to another embodiment of the present invention.

Referring to FIG. 6, the spindle motor 300 according to another embodiment of the present invention may include a base member 210, a lower thrust member 220, a shaft 230, a rotating body 240, and a cover member 280 by way of example.

Since the base member 210, the lower thrust member 220, the shaft 230, the rotating body 240, and the cover member 280 included in the spindle motor 300 according to another embodiment of the present invention are the same as the base member 210, the lower thrust member 220, the shaft 230, the rotating body 240, and the cover member 280 included in the spindle motor 200 according to another embodiment of the present invention except for an outer diameter reduction part 334 of a shaft 230 to be described below, a detailed description thereof will be omitted and be replaced with the above-mentioned description.

The shaft 230 may include an outer diameter reduction part 334 disposed at a lower end portion thereof, wherein the outer diameter reduction part 334 has the lower thrust member 220 bonded thereto. In addition, the outer diameter reduction part 334 may have a roughness greater than other portions.

Meanwhile, the outer diameter reduction part 334 may have an adhesive groove 334a formed at an upper end portion thereof, wherein the adhesive groove 334a is filled with an adhesive applied in order to bond the shaft 230 and the lower thrust member 220 to each other. In addition, the adhesive groove 334a may be filled with the adhesive to increase coupling force between the shaft 230 and the lower thrust member 220.

Meanwhile, an edge of the outer diameter reduction part 334 or a lower end portion of an inner surface of the lower thrust member 220 maybe provided with a rounded part or a chamfer in order to facilitate attachment of the shaft 230 to the lower thrust member 220.

Hereinafter, a spindle motor according to another embodiment of the present invention will be described with reference to the accompanying drawings.

FIG. 7 is a schematic cross-sectional view illustrating a spindle motor according to another embodiment of the present invention.

Referring to FIG. 7, the spindle motor 400 according to another embodiment of the present invention may include a base member 210, a lower thrust member 220, a shaft 430, a rotating body 240, and a cover member 280 by way of example.

Meanwhile, since the base member 210, the lower thrust member 220, the rotating body 240, and the cover member 280 included in the spindle motor 400 according to another embodiment of the present invention are the same as the base member 210, the lower thrust member 220, the rotating body 240, and the cover member 280 included in the spindle motor 200 according to another embodiment of the present invention described above, a detailed description thereof will be omitted.

The shaft 430 may have a lower end portion fixedly installed on the lower thrust member 220. Meanwhile, the shaft 430 may have an upper end portion provided with an upper thrust part 432.

The upper thrust part 432 may have a disk shape, and does not include the protrusion jaw 232b, unlike the upper thrust part 232 included in the spindle motor 200 according to another embodiment of the present invention described above.

Therefore, the insertion groove 252 is not formed in the sleeve part 250 of the rotating body 240.

Meanwhile, an outer peripheral surface of the upper thrust part 432 may be provided with an inclined surface 432c so as to form, together with a facing surface 242 of the rotating body 240 disposed to face the outer peripheral surface of the upper thrust part 432, an interface between the lubricating fluid and air (that is, a liquid-vapor interface).

More specifically, an upper end portion of the outer peripheral surface of the upper thrust part 432 may be provided with the inclined surface 432c so that an outer diameter of the upper thrust part 432 is decreased, and the liquid-vapor interface may be formed in a clearance formed by the inclined surface 432c and the facing surface 242 of the rotating body 240 by a capillary phenomenon.

In addition, the upper thrust part 432 may have a step part 432d formed in an upper surface thereof.

Meanwhile, the shaft 430 may have a roughness greater in a portion to which the lower thrust member 220 is bonded than in other portions. In other words, the lower end portion of the shaft 430 may have a surface rougher than other portions.

Therefore, coupling force between the lower thrust member 220 and the shaft 430 may be increased.

As set forth above, according to embodiments of the present invention, since a minimum thickness of the connection part of the rotating body has a smaller value between L1 and L2 and 0.5 mm<min{L1, L2}<{(H−0.3)−(h1+h2+h3)}/cos θ is satisfied, inclination of the disk due to external force applied at the time of installing the clamp may be decreased.

That is, a phenomenon in which an edge of the rotor hub part sags in the downward axial direction due to the external force applied at the time of installing the clamp may be decreased.

In addition, the shaft includes the flange part and the bonding part, such that separation of the shaft due to external impacts may be decreased.

Further, a surface roughness of the upper end portion of the shaft to which the thrust member is bonded is changed, such that separation between the shaft and the thrust member due to the external impacts may be decreased.

Furthermore, a surface roughness of the lower end portion of the shaft to which the lower thrust member is bonded is changed, such that separation between the shaft and the lower thrust member due to the external impacts may be decreased.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a base member provided with an installation part on which a stator core is fixedly installed;
a shaft including a body part having a cylindrical shape, a flange part extended from a lower end portion of the body part, and a bonding part extended from the flange part in an axial direction and bonded to an inner peripheral surface of the installation part;
a thrust member fixedly installed on an upper end portion of the shaft; and
a rotating body including a sleeve part disposed between the thrust member and the flange part of the shaft, a connection part extended from the sleeve part, and a rotor hub part extended from the connection part,
wherein when the shortest distance between the thrust member and the bonding part is L1, the shortest distance between the thrust member and the installation part is L2, a thickness of a hard disk drive is H, a vertical distance from the uppermost surface of the thrust member to the lowermost surface thereof is h1, a thickness of the flange part is h2, a vertical distance of the bonding part from an upper surface of the flange part is h3, and an angle between a line extended from an outer peripheral surface of the thrust member and a connection line having a smaller value between L1 and L2 is θ, and when a thickness of the connection part is determined by a smaller value between L1 and L2, 0.5 mm<min{L1, L2}<{(H−0.3)−(h1+h2+h3)}/cos θ is satisfied.

2. The spindle motor of claim 1, further comprising a cover member fixedly installed on the rotating body or the thrust member so as to prevent a lubricating fluid from being leaked from a clearance formed by the rotating body and the thrust member.

3. The spindle motor of claim 1, wherein the shaft includes an outer diameter reduction part to which the thrust member is bonded.

4. The spindle motor of claim 1, wherein the shaft has a greater degree of roughness in a portion to which the thrust member is bonded than in other portions.

5. The spindle motor of claim 1, wherein the thrust member includes an insertion protrusion part inserted into an insertion groove formed in the sleeve part.

6. The spindle motor of claim 1, wherein the outer peripheral surface of the thrust member is provided with an inclined surface so as to form, together with a facing surface of the rotating body disposed to face the outer peripheral surface of the thrust member, an interface between a lubricating fluid and air.

7. The spindle motor of claim 1, wherein a lower end portion of an outer peripheral surface of the sleeve part is provided with an inclined part so as to form, together with an inner peripheral surface of the bonding part, an interface between a lubricating fluid and air.

8. The spindle motor of claim 1, wherein the sleeve part is provided with a circulation hole formed in the axial direction.

9. The spindle motor of claim 1, wherein upper and lower radial dynamic grooves are formed in at least one of an inner peripheral surface of the sleeve part and an outer peripheral surface of the body part.

10. The spindle motor of claim 1, wherein an upper thrust dynamic groove is formed in at least one of a lower surface of the thrust member and an upper surface of the sleeve part.

11. The spindle motor of claim 1, wherein a lower thrust dynamic groove is formed in at least one of an upper surface of the flange part and a lower surface of the sleeve part.

12. The spindle motor of claim 1, wherein the rotor hub part is installed with a driving magnet disposed to face a front edge of the stator core, and
the magnetic center of the driving magnet in the axial direction is disposed in a position higher than that of the magnetic center of the stator core in the axial direction.

13. The spindle motor of claim 1, wherein the sleeve part, the connection part, and the rotor hub part are formed integrally with each other.

14. A spindle motor comprising:
a base member provided with an installation part on which a stator core is fixedly installed;
a lower thrust member inserted into the installation part to thereby be fixedly installed in the installation part and including a disk part having a disk shape and a bonding part extended from an edge of the disk part;
a shaft having a lower end portion fixedly installed on the lower thrust member and an upper end portion provided with an upper thrust part; and
a rotating body including a sleeve part disposed between the upper thrust part and the lower thrust member, a connection part extended from the sleeve part, and a rotor hub part extended from the connection part,
wherein when the shortest distance between the upper thrust part and the bonding part is L1, the shortest distance between the upper thrust part and the installation part is L2, a thickness of a hard disk drive is H, a vertical distance from the uppermost surface of the upper thrust part to the lowermost surface thereof is h1, a thickness of the disk part is h2, a vertical distance of the bonding part from the disk part is h3, and an angle between a line extended from an outer peripheral surface of the upper thrust part and a connection line having a smaller value between L1 and L2 is θ, and when a thickness of the connection part is determined by a smaller value between L1 and L2, 0.5 mm<min{L1, L2}<{(H−0.3)−(h1+h2+h3)}/cos θ is satisfied.

15. The spindle motor of claim 14, further comprising a cover member fixedly installed on the rotating body or the upper thrust part so as to prevent a lubricating fluid from being leaked from a clearance formed by the rotating body and the upper thrust part.

16. The spindle motor of claim 14, wherein the shaft has a greater degree of roughness in a portion to which the lower thrust member is bonded than in other portions.

17. The spindle motor of claim 14, wherein the shaft includes an outer diameter reduction part disposed at a lower end portion thereof, the outer diameter reduction part having the lower thrust member bonded thereto.

18. The spindle motor of claim 14, wherein the upper thrust part includes a flange extended from the upper end portion of the shaft in a radial direction and a protrusion jaw extended from an edge of the flange in a downward axial direction.

19. The spindle motor of claim 18, wherein the protrusion jaw is inserted into an insertion groove formed in the sleeve part.

20. The spindle motor of claim 18, wherein an upper thrust dynamic groove is formed in at least one of a lower surface of the flange and an upper surface of the sleeve part.

21. The spindle motor of claim 14, wherein the sleeve part is provided with a circulation hole formed in an axial direction.

22. The spindle motor of claim 14, wherein the sleeve part, the connection part, and the rotor hub part are formed integrally with each other.
